(19) United States
(12) Patent Application Publication
(10) Pub. No.: US 2014/0268806 A1
(43) Pub. Date: Sep. 18, 2014

(54) Backlight Module with Composite Reflective Surface

(71) Applicant: AU Optronics Corporation, Hsin-Chu (TW)

(72) Inventors: Zong-Huei Tsai, Hsin-Chu (TW); Shau-Yu Tsai, Hsin-Chu (TW)

(73) Assignee: AU Optronics Corporation, Hsin-Chu (TW)

(21) Appl. No.: 14/175,048

(22) Filed: Feb. 7, 2014

(30) Foreign Application Priority Data
Mar. 15, 2013 (TW) 102109262

(51) Int. Cl. F21V 7/00

(52) U.S. Cl. CPC F21V 7/0025
USPC 362/297

(57) ABSTRACT

A backlight module includes a reflective bottom surface, a light-exit top surface, and a light source module. The reflective bottom surface has a light-entrance side and the light source module is disposed along the light entrance side. The light-exit top surface is disposed opposite to the reflective bottom surface and sandwiches a mezzanine space with the reflective bottom surface. Light generated from the light source module enters the mezzanine space through the light-entrance side and is reflected by the reflective bottom surface to the light-exit top surface. The reflective bottom surface includes at least one first reflective surface and at least one second reflective surface arranged in intervals along an extending direction of the light-entrance side. A specular reflection ratio of the first reflective surface is greater than the specular reflection ratio of the second reflective surface.

### BACKGROUND OF THE INVENTION

1. Field of the Invention

The present invention generally relates to a backlight module; particularly, the present invention relates to a backlight module having a composite reflective surface.

2. Description of the Related Art

In terms of design of liquid crystal display (LCD) devices, background modules have always been important. Particularly, in order to meet the design trends of larger and slimmer displays, there is a necessity for designs of backlight modules to advance forward in concert with designs of LCDs. Additionally, backlight modules may also be applicable to other fields. However, the question of how to maintain a certain degree of uniform backlight within a backlight region of large surface area is a common development issue among all the different backlight modules.

FIG. 1A illustrates a conventional hollow backlight module. As shown in FIG. 1A, the backlight module includes a light source 10 and a cavity 20. A reflective surface 21 is disposed at the bottom surface of the cavity, wherein a light-exit surface 23 is opposite to the reflective surface 21. Light generated by the light source 10 enters the cavity 20 from a side of the cavity 20 and then is emitted out through the light-exit surface 23 after reflecting off the reflective surface 21. Due to the fact that different materials used for the reflective surface 21 will have different mirror reflectivity rates (ie. the rate of all light reflecting off the mirror surface of the reflective surface 21), different materials are frequently sought out to manufacture the reflective surface 21 with different mirror surface reflectivity rates in order to satisfy different design requirements. As a result, the manufacturing difficulties as well as costs are relatively high.

In addition, when these types of backlight modules are applied to larger dimensioned designs or flat and slim designs, they typically result in undesirable backlight unevenness. As shown in FIG. 1B, it can evidently be seen that the center, upper end, and lower end of the backlight module display uneven brightness levels. Accordingly, there is a need for improvements.

### SUMMARY OF THE INVENTION

It is an object of the present invention to provide a backlight module having a composite reflective surface that can have different mirror surface reflective rates.

It is another object of the present invention to provide a backlight module having a composite reflective surface to satisfy backlighting requirements of large dimension or slim designs.

The backlight module includes a reflective bottom surface, a light-exit top surface, and light source module. The reflective bottom surface has a light-entrance side, wherein the light source module is disposed along the light-entrance side. The light-exit top surface is disposed opposite the reflective bottom surface and sandwiches a mezzanine space with the reflective bottom surface. Light generated by the light source module is reflected by the reflective bottom surface to pass through the mezzanine space and then out of the light-exit top surface. The reflective bottom surface has at least one first reflective surface and at least one second reflective surface arranged in intervals along an extending direction of the light-entrance side. A specular reflection ratio of the first reflective surface is greater than the specular reflection ratio of the second reflective surface, wherein the specular reflection ratio is preferably the ratio of the amount of light reflected by the reflective surface to the total amount of light being reflected. By way of this design where the reflection ratio of the first reflective surface and the second reflective surface are constant but different, the reflection ratio of the entire reflective surface may be adjusted suitably to different backlight design requirements through combining and adjusting the ratio of the two reflective surfaces.

### BRIEF DESCRIPTION OF THE DRAWINGS

FIG. 1A is a view of the conventional hallow backlight module;

FIG. 1B is a test result for backlight uniformity of the conventional hallow backlight module;

FIG. 2A is a cross-sectional view of an embodiment of the backlight module of the present invention;

FIG. 2B is a top view of the embodiment of FIG. 2A;

FIGS. 3A and 3B are embodiments having scattering strips;

FIG. 4 is an embodiment with the first reflective area and the second reflective area;

FIG. 5 is a test result for backlight uniformity of the backlight module of the present invention;

FIG. 6 is another embodiment of FIG. 4;

FIG. 7 is another embodiment of FIG. 4; and

FIG. 8 is an embodiment of the backlight module with reflective curved surfaces.

### DETAILED DESCRIPTION OF THE PREFERRED EMBODIMENT

The present invention provides a backlight module of a mosaic of reflective surfaces and the mosaic of reflective surfaces. In a preferred embodiment, the backlight module of the present invention is utilized in liquid crystal display devices. However, in other different embodiments, the backlight module of the present invention may also be utilized in other different electronic devices. In addition, the backlight module of the present invention is preferably a design of hallow reflecting cavity. However, the spirit of the present invention of mosaic reflective surface may also be applied to other different backlight module designs.

In the embodiment of FIGS. 2A and 2B, the backlight module includes reflective bottom surface 100, light-exit top surface 200, and light source module 300. The reflective bottom surface 100 has a light entrance side 110, whereas the light source module 300 is disposed outside of the reflective bottom surface 100 along the light entrance side 110. As shown in FIG. 2A, the light-exit top surface 200 is disposed opposite the reflective bottom surface 100 and sandwiches a mezzanine space 400 with the reflective bottom surface 100. Light generated by the light source module 300 preferably enters the mezzanine space 400 through the light entrance side 110, and then is reflected by the reflective bottom surface 100 to pass through the mezzanine space 400 to reach the light-exit top surface 200 such that the light eventually is emitted out of the light-exit top surface 200. The mezzanine space 400 is preferably only accommodates a gas as a medium. However, in other different embodiments, optical films or boards of different properties or may also be disposed in the mezzanine space 400 to increase the optical performance of the entire backlight module. In addition, in a preferred embodiment, a ratio L/H of length L of the light exit top surface 200 perpendicular to the direction of the light entrance side to height H of the mezzanine space 400 is preferably greater than 20 in order to be applicable to large dimensioned or slim designs of display devices.

As shown in FIG. 2B, the reflective bottom surface 100 includes at least a first reflective surface 510 and at least a second reflective surface 520. The first reflective surface 510 and the second reflective surface 520 are arranged in intervals along an extending direction of the light entrance side 110. In better terms, in the extending direction 111, at least one second reflective surface 520 is disposed between two first reflective surfaces 510, or at least one first reflective surface 510 is disposed between two second reflective surfaces 520. The specular reflection ratio of the first reflective surface 510 is greater than the specular reflection ratio of the second reflective surface 520. When light is reflected by the first reflective surface 510 or the second reflective surface 520, a portion of the light will be reflected in a specular reflective fashion while another portion of the light will be reflected in a scattering reflective fashion. The specular reflection ratio is preferably the ratio of the light being reflected in the specular reflective fashion to the total amount of light being reflected. Through this design, in the circumstance where the specular reflection ratio of the first reflective surface 510 and the second reflective surface 520 are constant but different, the specular reflection ratio of the entire reflective bottom surface 100 may be adjusted to suit different backlight design requirements by adjusting the area ratio and combination of the first reflective surface 510 and the second reflective surface 520.

In the present embodiment, as shown in FIG. 2B, the first reflective surface 510 and the second reflective surface 520 are preferably rectangular shapes, wherein the longest side of the rectangular shape is perpendicular to the extending direction 111 of the light entrance side 110. In other words, the longest sides of the first reflective surface 510 and the second reflective surface 520 are approximately parallel to the forward direction of the light exiting direction such that after the first reflective surface 510 and the second reflective surface 520 are composited or assembled, the first reflective surface 510 and the second reflective surface 520 may provide a better reflective surface shape. In addition, since the sectional width of the first reflective surface 510 and the second reflective surface 520 are narrower along the extending direction 111 than along the longest side, much more first reflective surfaces 510 and second reflective surfaces 520 may be arranged in the same span of distance. Therefore, better mixing effect with the first reflective surface 510 and the second reflective surface 520 may be achieved. However, in other different embodiments, the first reflective surface 510 and the second reflective surface 520 may be different shapes, or may be arranged or assembled extending in the extending direction 111 inclined to the light entrance side 110.

In addition, as shown in FIG. 2B, the light source module 300 includes a plurality of light-emitting units 310, wherein the light-emitting units 310 are preferably light-emitting diodes. In the present embodiment, at least one of the light-emitting units 310 is aligned in position with a seam between the first reflective surface 510 and the second reflective surface 520. In other words, the light-emitting unit 310 is disposed along the extending line of the seam between the first reflective surface 510 and the second reflective surface 520. Through this design, a portion of light generated by the light-emitting unit 310 may be emitted to the area of the first reflective surface 510 with another portion being emitted to the area of the second reflective surface 520. Therefore, the light generated by the light-emitting unit 310 may be uniformly distributed or allocated to the first reflective surface 510 and the second reflective surface 520 such that the effect of mixed lighting may be increased while decreasing the possibility of the backlight being non-uniformly distributed. In addition, this design can also allow the backlight property that is actually produced to be very nearly the same as the default backlight property when the ratio of the first reflective surface 510 and the second reflective surface 520 was first adjusted. Conversely, in other different embodiments, the light-emitting unit 310 may be aligned at a center point between the first reflective surface 510 and the second reflective surface 520, or may be aligned not particularly in reference to the first reflective surface 510 or the second reflective surface 520 such that a different backlight property may be obtained.

FIGS. 3A and 3B illustrate another embodiment of the present invention. In the present embodiment, the reflective bottom surface has a scattering strip 130 disposed along the light-entrance side 110. In other words, the scattering strip 130 is distributed in the extending direction 111 along the light-entrance side 110. The scattering strip 130 is preferably positioned between the first reflective surface 510 and the second reflective surface 520. In other words, the first reflective surface 510 and the second reflective surface 520 would need to pass by the scattering strip 130 to reach the light-entrance side 110. The specular reflection ratio of the scattering strip 130 is preferably smaller than the specular reflection ratio of the first reflective surface 510. The specular reflection ratio of the scattering strip 130 may also be smaller than the specular reflection ratio of the second reflective surface 520. Since a portion of the light of the light source module may arrive at the reflective bottom surface 100 at a smaller inclination (ex. Nearly perpendicular to the reflective bottom surface 100) and then is emitted out through the light-exit top surface 200 after being reflected by the reflective bottom surface 100, these portions of light may produce bright strips or light leakage at the fringe areas. Through the design of the scattering strip 130, these types of light may be partially scattered and prevented from being directly reflected such that the possibility of occurrence of bright strips or light leakage may be reduced.

FIG. 4 illustrates another embodiment of the reflective bottom surface 100. In the present embodiment, the reflective bottom surface 100 may be partitioned as a first reflective area 710 and a second reflective area 720. The first reflective area 710 and the second reflective area 720 are preferably distributed along the extending direction 111 of the light entrance side 110, wherein the first reflective area 710 is closer to the light entrance side 110. In other words, the second reflective area 720 is positioned at a side of the first reflective area 710 opposite of the side of the first reflective 710 that is closest to the light entrance side 110. The first reflective surface 510 and the second reflective surface 520 are distributed in the first reflective area 710, whereas at least one third reflective surface 530 and at least one fourth reflective surface 540 are disposed in the second reflective area 720. The third reflective surface 530 and the fourth reflective surface 540 are arranged in intervals along the extending direction 111 of the light entrance side 110. In preferable terms, at least one fourth reflective surface 540 is disposed between two third reflective surfaces 530 in the extending direction 111, or at least one third reflective surface 530 is disposed between two fourth reflective surfaces 540. The specular reflection ratio of the third reflective surface 530 is greater than the specular reflection ratio of the fourth reflective surface 540.

In comparison between the first reflective area 710 and the second reflective area 720, the area-weighted average specular reflection ratio of the first reflective area 710 is greater than the area-weighted average specular reflection ratio of the second reflective area 720. In more definite terms, the area-weighted average specular reflection ratio of the first reflective area 710 is the sum of the multiplication of the specular reflection ratio of the first reflective surface 510 with its total surface area and the multiplication of the specular reflection ratio of the second reflective surface 520 with its total surface area, divided by the total surface area of the first reflective area 710. The area-weighted average specular reflection ratio of the second reflective area 720 may also be calculated in similar fashion. Since the area-weighted average specular reflection ratio of the first reflective area 710 is relatively greater, more light will be transmitted backwards (ie. in the direction of the second reflective area 720), wherein the light will then be scattered out in the second reflective area 720. Through this design, the present embodiment may be applied to larger dimensioned or slimmer display devices while maintaining the backlight uniformity. As shown in FIG. 5, when utilizing the design of the first reflective area 710 and the second reflective area 720, the backlight uniformity on a 75 inch backlight module may on average be as high as 80% with the light distribution being more uniform.

In the embodiment illustrated in FIG. 4, seams between adjacent first reflective surface 510 and second reflective surface 520 are preferably misaligned with seams between adjacent third reflective surface 530 and fourth reflective surface 540. In other words, the seams between the first reflective area 710 and the second reflective area 720 are preferably non collinear. Through this design, portions of the light transmitted backwards by the first reflective surface 510 or the second reflective surface 520 of the first reflective area 710 may be emitted to the area of the third reflective surface 530, while another portion of the light is emitted to the area of the fourth reflective surface 540. Therefore, light transmitted backwards by the first reflective area 710 may be uniformly distributed or allocated to the third reflective surface 530 and the fourth reflective surface 540 in order to increase the light mixing effect while decreasing the possibility of the backlight being non-uniform. However, in other different embodiments, as shown in FIG. 6, the seams between adjacent first reflective surface 510 and second reflective surface 520 are preferably aligned with the seams between adjacent third reflective surface 530 and fourth reflective surface 540. In the present embodiment, adjacent first reflective surface 510 and second reflective surface 520 jointly correspond to the same third reflective surface 530 or fourth reflective surface 540. In such a manner, the light mixing effect may be increased while the possibility of the backlight being non-uniform may be decreased.

In addition, as shown in FIGS. 4 and 6, the width of the first reflective surface 510 and the second reflective surface 520 in the extending direction 111 is smaller than the width of the third reflective surface 530 and the fourth reflective surface 540 in the same direction such that the first reflective surface 510 and the second reflective surface 520 are slimmer than the third reflective surface 530 and the fourth reflective surface 540. However, in length-wise direction of the first reflective surface 510 and the second reflective surface 520, the length of the first reflective surface 510 and the second reflective surface 520 is longer than the length of the third reflective surface 530 and the fourth reflective surface 540 in the same direction.

FIG. 7 illustrates another embodiment. In the present embodiment, the first reflective surfaces 510 and the third reflective surfaces 530 have similar specular reflection ratios, while the second reflective surfaces 520 and the fourth reflective surfaces 540 have similar specular reflection ratios. In order to allow the first reflective area 710 to have a greater weighted-average specular reflection ratio, the ratio of the surface area occupied by the first reflective surface 510 in the first reflective area 710 must be greater than the ratio of the surface area occupied by the third reflective surface 530 in the second reflective area 720. In more definite terms, the ratio of the total surface area of the first reflective surface 510 to the total surface area of the second reflective surface 520 is preferably greater than the ratio of the total surface area of the third reflective surface 530 to the total surface area of the fourth reflective surface 540. Through this design, Materials with different specular reflection ratios may be utilized, wherein different average specular reflection ratios of the first reflective area 710 and the second reflective area 720 may be assembled or composited together such that the average specular reflection ratio of each area is different from the specular reflection ratio that the original material by itself possesses.

As illustrated in FIG. 8, the light source module includes a reflective curved surface 330 and a light source 301. The reflective curved surface 330 and the light source 301 are distributed along the light entrance side 110, wherein one side of the reflective curved surface 330 is adjacent to the light entrance side 110. The reflective curved surface 330 is preferably curved around an axis in the extending direction 111 of the light entrance side 110 (FIG. 8 illustrates the extending direction 111 to be perpendicular to the cross-sectional view). In more definite terms, the reflective curved surface 330 extends out from the light entrance side 110 and curves or curls in the direction of the light-exit top surface 200. The light source 301 is positioned on top of the reflective curved surface 330. That is, the light source 301 is disposed in the concave side of the reflective curved surface 330. Light generated by the light source 301 enters the mezzanine space 400 after being reflected by the reflective curved surface 330, wherein at least a portion of the light reaches the reflective bottom surface 100. Since the reflecting of light is preferably performed by the concave side of the reflective curved surface 330, the reflected light may be more concentrated to be transmitted into the mezzanine space 400 such that losses in light performance may be decreased.

As shown in FIG. 8, the light source 301 has a light-emitting forward direction 303 (ie. a centerline direction of the range of light emitted by the light source 301). In the present embodiment, the light source 302 includes a plurality of light-emitting units 310, such as light-emitting diodes. The light-emitting forward direction 303 represents the normal direction to the light-emitting surface of the light-emitting unit 310. The light-emitting forward direction 303 preferably is inclined at an incline angle θ in relation to the normal direction of the light-exit top surface 200 heading away from the mezzanine space 400, wherein the incline angle θ is preferably between 5 degrees and 40 degrees. Through this design, light from the light source module 300 may arrive at the reflective bottom surface 100 at a greater angle in order to decrease the circumstance of bright strips or light leakage from occurring at the fringe areas.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A backlight module, comprising:
a reflective bottom surface having a light-entrance side, wherein the reflective bottom surface has at least one first reflective surface and at least one second reflective surface arranged in intervals along an extending direction of the light-entrance side, and a specular reflection ratio of the first reflective surface is greater than the specular reflection ratio of the second reflective surface;
a light-exit top surface disposed opposite to the reflective bottom surface and sandwiching a mezzanine space with the reflective bottom surface; and
a light source module disposed along the light-entrance side;
wherein at least a portion of light generated by the light source module is reflected by the reflective bottom surface to pass through the mezzanine space and then out of the light-exit top surface.

2. The backlight module of claim 1, wherein the at least one first reflective surface and the at least one second reflective surface are rectangular shapes, and a length-wise direction of the at least one first reflective surface and the at least one second reflective surface is perpendicular to an extending direction of the light-entrance side.

3. The backlight module of claim 1, wherein the reflective bottom surface has a scattering strip disposed along the light-entrance side and between the at least one first reflective surface and the at least one second reflective surface, and the specular reflection ratio of the scattering strip is smaller than the specular reflection ratio of the at least one first reflective surface.

4. The backlight module of claim 1, wherein the reflective bottom surface comprises:
a first reflective area, wherein the at least one first reflective surface and the at least one second reflective surface are distributed in the first reflective area; and
a second reflective area positioned at another side of the light-entrance side opposite to the first reflective area, the second reflective area has at least one third reflective surface and at least one fourth reflective surface arranged in intervals along the extending direction of the light-entrance side, and the specular reflection ratio of the at least one third reflective surface is greater than the specular reflection ratio of the at least one fourth reflective surface;
wherein an area-weighted average specular reflection ratio of the first reflective area is greater than the area-weighted average specular reflection ratio of the second reflective area.

5. The backlight module of claim 4, wherein seams between the at least one first reflective surface and the at least one second reflective surface that are adjacent are mutually misaligned with the seams between the at least one third reflective surface and the at least one fourth reflective surface that are adjacent.

6. The backlight module of claim 4, wherein seams between the at least one first reflective surface and the at least one second reflective surface that are adjacent are mutually aligned with the seams between the at least one third reflective surface and the at least one fourth reflective surface that are adjacent.

7. The backlight module of claim 4, wherein the specular reflection ratios of the at least one first reflective surface and the at least one third reflective surface are the same, the specular reflection ratios of the at least one second reflective surface and the at least one fourth reflective surface are the same, and a total area ratio of the at least one first reflective surface and the at least one second reflective surface is greater than the total area ratio of the at least one third reflective surface and the at least one fourth reflective surface.

8. The backlight module of claim 1, wherein the light source module includes:
a reflective curved surface distributed along the light-entrance side that arcs with the extending direction of the light-entrance side as an axis, wherein a side of the reflective curved surface is abut with the light-entrance side; and
a light source distributed along the light-entrance side positioned above and facing the reflective curved surface.

9. The backlight module of claim 8, wherein the light source has a light-emitting forward direction, the light-emitting forward direction is inclined at an incline angle in relation to a normal direction of the light-exit top surface heading away from the mezzanine space, and the incline angle is between 5 degrees and 40 degrees.

10. The backlight module of claim 8, wherein the light source includes a plurality of light-emitting units, and at least one of the light-emitting units is aligned in position with a seam between the at least one first reflective surface and the at least one second reflective surface that are adjacent.

11. The backlight module of claim 1, wherein the light source module includes a plurality of light-emitting units, and at least one of the light-emitting unit is aligned in position with a seam between the at least one first reflective surface and the at least one second reflective surface that are adjacent.

12. The backlight module of claim 1, wherein a ratio of the length of the light-exit top surface in a direction perpendicular to the light-entrance side and the height of the mezzanine space is greater than 20.
